(19) United States
(12) Patent Application Publication
(10) Pub. No.: US 2010/0133223 A1
(43) Pub. Date: Jun. 3, 2010

(54) DISPOSABLE BOTTLE DEVICE WITH A NON-REMOVABLE NIPPLE

(76) Inventor: Corwin Pearl Littell, II, Belle Isle, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/581,754

(22) Filed: Oct. 19, 2009

Related U.S. Application Data
(63) Continuation-in-part of application No. 11/411,661, filed on Apr. 26, 2006, now abandoned.
(60) Provisional application No. 61/106,402, filed on Oct. 17, 2008.
(60) Provisional application No. 60/675,790, filed on Apr. 28, 2005.

(51) Int. Cl. A61J 9/08; B65D 83/00

(52) U.S. Cl. 215/11.6; 215/387

(57) ABSTRACT

A system for permanently securing a nipple to a container, the system including an insertion element as part of a nipple or a container, a receiving element as part of the nipple or the container that does not include the insertion element, and a locking element as part of the insertion element and/or the receiving element to prohibit the nipple from being removed from the container. An apparatus for permanently securing a nipple to a container is also provided.

### CROSS-REFERENCE TO RELATED APPLICATIONS

This invention claims the benefit of U.S. Provisional Application No. 61/106,402 filed Oct. 17, 2008, and is a Continuation-In-Part of U.S. application Ser. No. 11/411,661 filed Apr. 26, 2006, which claims the benefit of U.S. Provisional Application No. 60/675,790 filed Apr. 28, 2005.

### BACKGROUND OF THE INVENTION

This present invention relates to disposable bottles and more particularly pertains to a disposable bottle for pre-packaged liquids that are sterilized, sealed and ready to use out of the package.

There are various problems and difficulties that have been encountered in providing people and animals of all age groups and, more specifically, babies with proper feeding by means of bottles, wherein bottles and their associated parts, as well as the contents should at all times be kept clean and sterilized. When a person or baby or animal is being fed at home or away from home the inherent problem is supplying liquid such as a food source or medication with the assurance that it is being administered from a sterile environment. Generally, the bottles are prepared and sterilized at home, which is time consuming and during which time the nipples and bottle parts are exposed to various contaminants both from being exposed to the environment and from the hands of the person that is preparing the bottle. Also, there is a possibility that not enough bottles have been prepared and the supply runs out when the bottle is needed the most, causing a chain reaction of events to happen such as a stop at the nearest restaurant without the time or facilities for sterilization thus potentially causing a biological disorder to occur such as projectile vomiting.

Even with the advent of disposable bottles, the problem of running out or the availability of sterilized milk or other sterilized liquids, such as formula or water, still exist. To the applicant's knowledge, there is no disposable baby bottle or any other type of disposable bottle available on the market today that can provide sterilized parts as well as sterilized food or liquids or medication in one package, where the bottle is pre-filled with any variety of liquids under ultimate, sterilized conditions, sealed as to not having to assemble any of the parts as described herein and being stored in such a way that maintains the integrity of being sterilized until the bottle as described herein is put into use.

Known prior art includes U.S. Pat. No. 4,678,092; U.S. Pat. No. 5,579,935; U.S. Pat. No. 3,777,025; U.S. Pat. No. 4,813,556; U.S. Pat. No. Des. 430,676; U.S. Pat. No. 6,737,091 B1. While these devices fulfill their respective, particular objectives and requirements, they do not disclose a new disposable bottle feeding device.

### BRIEF DESCRIPTION OF THE INVENTION

Exemplary embodiments of the present invention discloses a device for containing sterilized liquids including medication, water, protein, vitamins and liquid food sources of all types for individuals ranging from adults to babies and even animals, such as for the impoverished in remote areas and in disaster areas where supplies containing sterile liquids are not available.

A system for permanently securing a nipple to a container is provided. The system comprises an insertion element as part of a nipple or a container, and a receiving element as part of the nipple or the container that does not include the insertion element. A locking element is further provided that is a part of the insertion element and/or the receiving element to prohibit the nipple from being removed from the container.

An apparatus for securing a nipple to a sidewall of a container is also provided. The apparatus comprises a nipple with a connection element, a lip attachment, connected to a sidewall of the container, to receive a connection element on a nipple, and a locking element to prohibit the nipple from being removed from the lip attachment.

### BRIEF DESCRIPTION OF THE DRAWINGS

Exemplary embodiment of the invention will be better understood by the following detailed description taken in conjunction with the drawings in which:

FIG. 1 is a front cross-sectioned view of a new disposable bottle device according to the present invention;

FIG. 2 is a front cross-sectioned view of the disposable bottle with some liquid drawn out of the inner liner;

FIG. 3 is a front cross-sectioned view of the one-piece inner liner and nipple for the disposable bottle;

FIG. 4 is a front cross-sectioned view of a two-piece sidewall for the disposable bottle;

FIG. 5 is a front cross-sectioned view of a one-piece sidewall for the disposable bottle;

FIG. 6 is a front cross-sectioned view of a disposable bottle showing a different method of attaching the nipple to the liner;

FIG. 7 is a front cross-sectioned view of a disposable bottle that is all one piece, having no inner liner where the sidewall and the nipple act as one in the same structure;

FIG. 8 is a perspective view of a lip on a disposable bottle; and

FIG. 9 is a perspective view of the nipple with a piercing device.

### DETAILED DESCRIPTION OF THE INVENTION

Before explaining the embodiments of the invention in detail, it is to be understood that the invention is not limited in its application to the details of construction and or in the arrangements of the components set fourth in the following description of illustrated in the drawings. The invention is capable of other embodiments and is capable of being practiced and carried out in various ways depending on the application it is used in. Also, it is to be understood that the phraseology and terminology employed herein are for the purpose of description and should not be regarded as limiting.

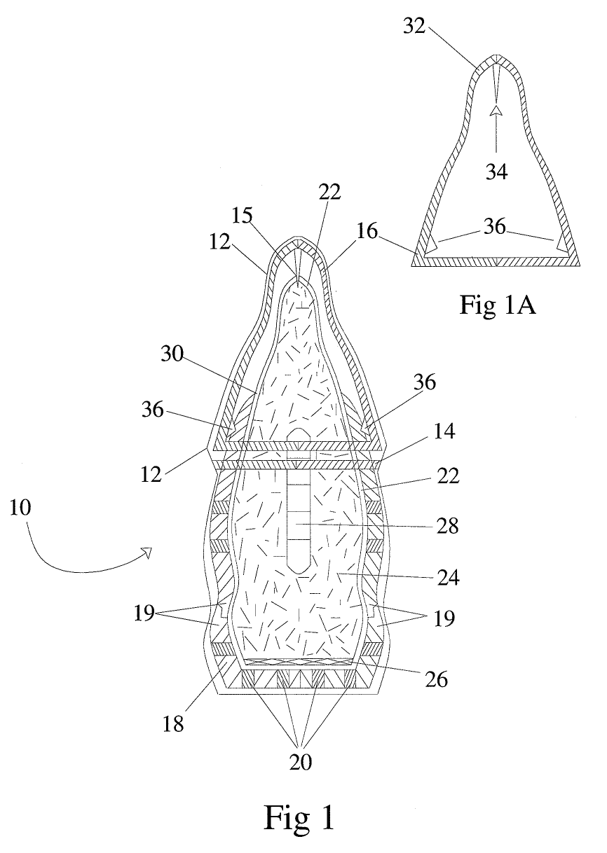

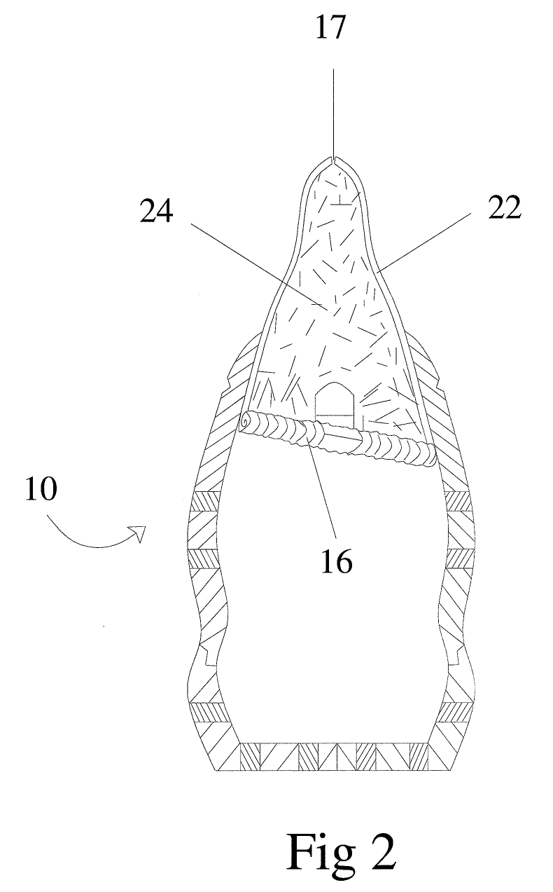

Referring to FIG. 1, there is shown a front, cross-sectioned view of a disposable bottle device 10, or container, according to one embodiment of the present invention. A thin layer of plastic or other pliable material 12 that can cover all parts of device 10, or container, or just the protective cap 16 of the disposable bottle device functions as a protective safety wrap intended to be removed prior to use for the purpose of protecting the over-all integrity of the disposable bottle device and it's contents prior to purchase. A zipper-seal 14 in the same manner as a safety seal that is installed on a new bottle top on a common plastic disposable soda container can be used to insure the integrity of the disposable bottle and its contents while providing easy opening access. FIG. 1A is a front, cross-sectioned view of the protective cap 16 comprised of a single piece 32 or multiple pieces of ridged or pliable material such as plastic generally made using an injection mold, thus allowing close tolerances so that the protective cap would snap into place by means of ridges or extrusions 36, or by a means that is determined by the manufacturer which would be suitable for this device when it is affixed to the device sidewall 18 for the purposes of preventing it from falling off the sidewall 18 when the disposable bottle is not being used. The cap 16 also protects the nipple 22 from damage and contact with germs, bacteria or any substance that would harm or be foreign to the user or contents of the disposable bottle. A protrusion 34 acts as a stopper when the protective cap 32 is installed on the sidewall 18 which in turn puts downward pressure on the feeding hole which is located at the top of the nipple as shown in FIG. 2 at 17. When the protective cap 16 is put back on a partially used disposable bottle and snapped into place the nipple will not leak since the cap is pressed against the nipple top blocking hole 17.

A two-piece sidewall 18 of material such as plastic, silicone, rubber, glass, aluminum, metal or any other pliable or rigid material that would be suitable for this invention including being made of a material that is determined by need, or environment, or regulation, or cost, or health issues forms a bottom support for the bottle or device 10. The side wall 18 is joined for the purposes of this illustration at 19 but can be joined or separated at any location of the sidewall whether it be horizontally at the bottom or top or middle of sidewall 18, or vertically down the middle from top to bottom of the sidewall which can be determined by the manufacturer or individual needs, but is intended to be joined together in a fixed fashion for the purpose of supporting and protecting the entire structure 10 from outside damage or contamination in the course of normal use, and for the purposes of housing the nipple/liner 22 before or after it is filled with prepackaged liquids 24. Openings 20 in the sidewall 18 are located throughout the sidewall 18 but are not limited to any particular location or size or shape on the sidewall 18 and are intended to release any vacuum buildup that might be created when the bottle is being used including submerging the sidewall 18 in a liquid such as water for the purpose of heating or cooling the contents 24 that are inside the nipple/liner 22 thus allowing a liquid such as water to directly heat or cool the nipple/liner 22 and contents 24. Openings 20 are also used when draining a liquid used to heat or cool contents 24 out of the sidewall 18 once the contents 24 and nipple/liner 22 have been heated or cooled to the preferred temperature. The nipple/liner 22 can be made of plastic or silicone or rubber or any other pliable material that is nontoxic, sterilized and suitable for this invention. Nipple/liner 22 is one continuous part that functions as a container to store liquids 24 of all types including medication, vitamins, formula or foods regardless of their consistency including juices, water and milk all of which are prepackaged in the nipple/liner 22 at the manufacture through the filler area 26 in the liner. Filler area 26 is not limited to this exact location on the liner as the opening could be installed anywhere on the nipple/liner 22. Once the nipple/liner 22 has been filled with the desired liquid from the manufacturer to a capacity and volume that would minimize or eliminate any air that would be trapped inside the nipple/liner 22, the opening in the nipple/liner 26 can be sealed with glue or heat or fusion or stamping or cauterization or clamping or tying or folding or pressure or any other type of adhesion that is suitable for this invention that will provide a leak proof environment for the liquid 24 that is stored inside the nipple/liner 22 to insure the integrity of the nipple/liner 22 as well as the overall use of the disposable bottle device 10. Another use for the nipple/liner 22 is to form the nipple portion of the nipple/liner 22 which can be made from a different and thicker or thinner material other than the material of the liquid storing portion of the liner 22. In such a case, the nipple material would be molded into the liner material and the liner material into the nipple material in such away that it would function as one piece. However, the nipple could be made of the same material and thickness as liner 22 depending on the application that the nipple/liner is being used for. A heat strip 28 is attached to the nipple/liner 22 either on the inside or outside of the nipple/liner, or to the inside or the outside of the sidewall 18 for the purpose of showing temperature of the liquid 24. The strip 28 may be located at the general area 30 of the nipple/liner where 22 nipple/liner is attached to the sidewall 18 by means of adhesive or by glue or by heat or fusion or by snapping it or screwing it together in some way as to secure the nipple/liner 22 to the sidewall 18 when the device or bottle 10 is being used under normal conditions.

FIG. 2 illustrates how the nipple/liner 22 collapses when some of the liquid 24 has been extracted by suction applied via hole 17. The liner 22 will fold, or gather, to roll upward as shown at 16 thus preventing air from getting into the liquid 24 and eliminating or greatly reducing excess air intake to the user ingesting the liquid 24.

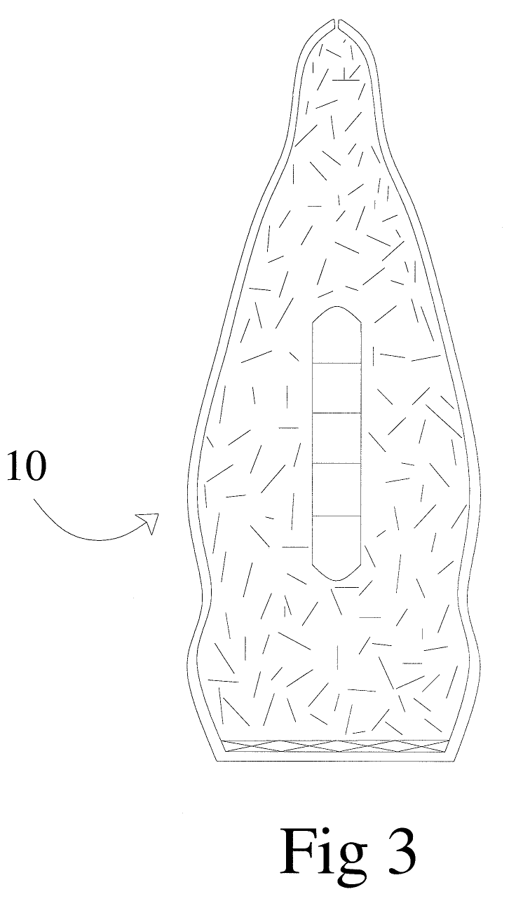

FIG. 3 illustrates a filled liner 22 in the inventive one piece nipple/liner configuration.

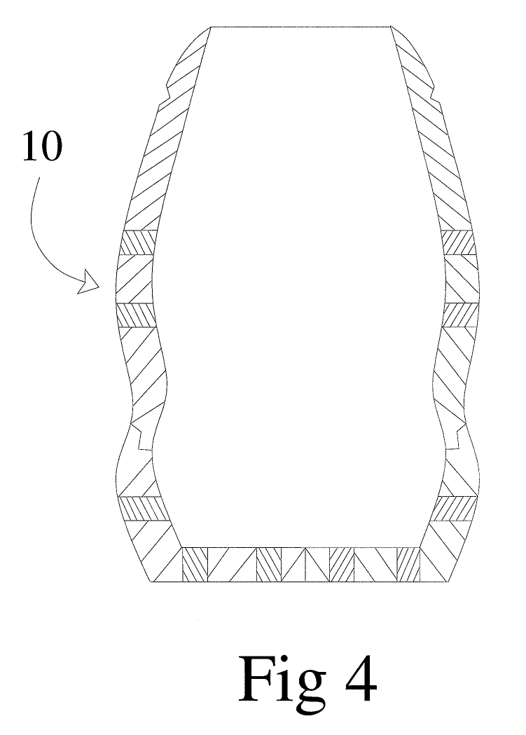

FIG. 4 illustrates one form of construction of the outer sidewall or support 18.

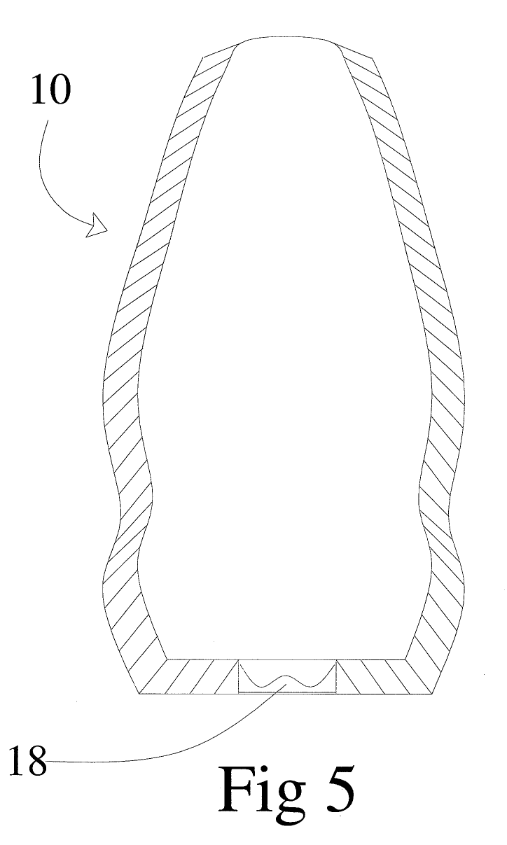

FIG. 5 illustrates a one-piece sidewall 18 construction for the disposable bottle device which has the same overall function as the two-piece sidewall of FIG. 4 but is intended to allow the nipple/liner 22 to be inserted from the top of the sidewall as opposed to the bottom of the sidewall 10.

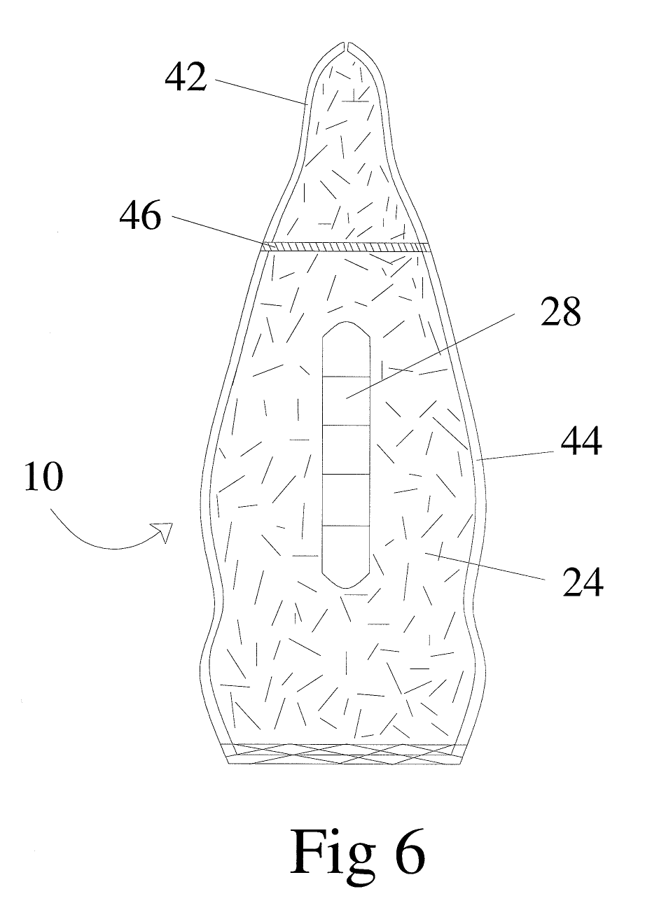

FIG. 6 illustrates an alternate embodiment in which the nipple/liner 22 is formed as a nipple 42 attached at 46, an attachment location or lip, to a liner 44 after filling the liner. The nipple and liner can be sealed together at 16 or other appropriate location with glue, heat, fusion, stamping, cauterization, clamping, tying, folding, pressure or any other type of adhesion that is suitable for this invention in a way as to be used as one structure, and in a way that will provide a leak proof environment for the liquid 24 that is stored inside the liner 44.

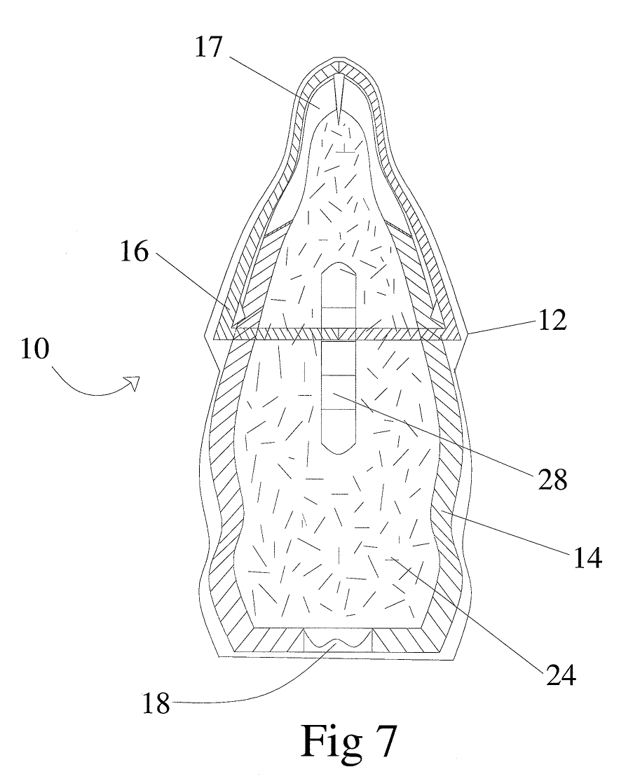

FIG. 7 illustrates a further embodiment of the invention having some of the same characteristics as in FIG. 1 including cover 12, the protective cap 16 and heat strip 28, all having the same functions as those parts noted in FIG. 1. The sidewall 18 has a nipple 42 built into it as part of the sidewall and made of the same or different material, and the nipple could be of a different thickness as the sidewall 18 but acting as one and the same structure, and could be attached or molded or glued or fused in such a way that would make the operation of the nipple function as one integral part of the sidewall, having no liner, meaning the liquid is placed inside the sidewall in a sterile environment and is drawn out of the disposable bottle through a hole at the top of the nipple, and having a filler hole 48 somewhere in the nipple/sidewall 18 so that liquid can be injected.

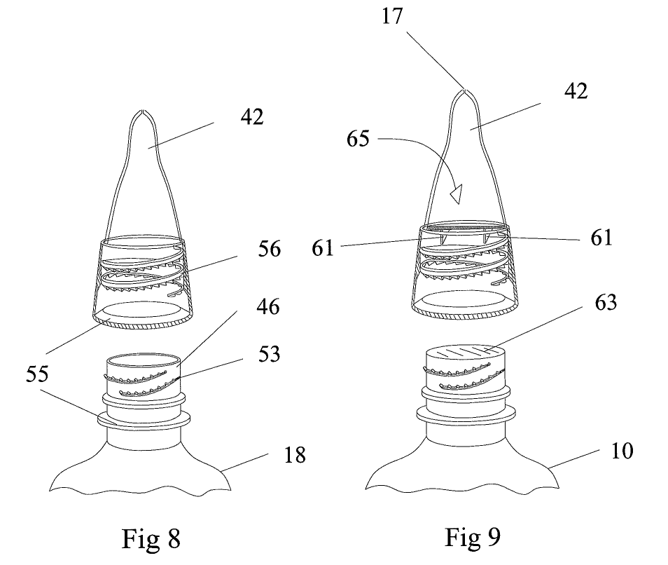

The attachment 46, in one exemplary embodiment is a lip configuration. As further illustrated in FIG. 8, the lip 46 has an inner configuration to allow the nipple to be secured to the sidewall 18. For example, the securing device may comprise a threaded connection between the lip 46 and the nipple 42. The securing device allows for the nipple 42 to be secured, and not removed from the sidewall 18, once in place.

For example, threads 53 are provided at the attachment location. The threads have at least one locking ridge 55 provided for use with the threads 53 to prevent a devices engaging the threads not to be able to be removed. Receiving threads 56 are provided on the nipple 42. Though threads are disclosed other forms of engaging techniques are applicable. For example, a channel with an engaging element that travels within the channel may be utilized.

At least one receiving locking ridge 57 is in use with the threads 53. The locking ridges 55, 57 are configured so that as the nipple 42 is screwed into place, both sets of locking ridges 55, 57 prohibit the nipple 42 from being turned counter-clockwise, or more specifically from being removed once engagement to the sidewall 18 has begun. Though locking ridges are disclosed, those skilled in the art will readily recognize that a plurality of other non-removable techniques may be used to secure the nipple to the sidewall 18. For example, only one set of threads, either on the nipple or on the attachment location may have the locking ridges. In another embodiment a detent may be used to secure the nipple to the attachment location 46. The detent may be located to prohibit the nipple from being removed once the nipple has fully engaged the threads at the attachment location 46, or it may be located to prohibit the nipple from being removed once the nipple has engaged the threads after a pre-defined amount of engagement. In yet another embodiment, the securing device, or mechanism, does not require a threaded engagement. Instead, in a broader sense a receiving element may be provided on either the nipple or at the attachment location 46 and an insertion element, that engages the receiving element, is provided at the other location. For clarification, the threading technique disclosed above may be considered as having the insertion element and the receiving element, wherein one threaded element is viewed as the insertion element and the other is viewed as the receiving element. The locking ridges and/or the detent may be considered a locking element.

Furthermore, though a baby nipple 42 is disclosed with respect to FIG. 8, this element is representative of any device through which a liquid may be removed from the container. For example, the “nipple” may be a baby bottle nipple, sipper lid, a lid with a spout, and/or a sports bottle top or cap, etc. Therefore, the term “nipple” is not to be limited to only a baby nipple. This term is meant to encompass any cap, lid, and/or cover that provide for a control over a flow of liquid from the container through an opening in the nipple.

FIG. 9 discloses the nipple 42 having a piercing device 61 to remove a protective covering 63 that may be used to enclose the liquid within the container 10. As illustrated, the piercing device 61 pierces the protective covering 63, allowing for the liquid in the container 10 to be able to reach the opening 17 in the nipple 42. As illustrated the piercing device 61 has a single point, with an opening 65, or entry, for the liquid to flow through. The piercing device 61 will widen the protective covering 63 as the nipple 42 is secured into place. Depending on the material comprising the protective covering 63, the protective covering will remain attached to the container but will have an opening created by the insertion of the piercing device 61.

The piercing device 61 may have other configurations as well. For example, the insertion device 61 may be configured to separate the protective covering from the container 10. In such a configuration, the protective covering may have a solute that may be dissolved in the liquid once submerged. This sort of piercing device may have an element that separates the protective covering 63 from the container as the nipple 42 is secured in place.

By utilizing a system or method to prohibit removal of the nipple once engaged to the sidewall, non-contaminated liquid in the bottle 10 is not risked with contamination when securing the nipple and the container. For example, if the bottle 10 is used in a desolate region of the world, the bottle 10 can be provided to individuals in this region of the world with liquid provided from a source that is known not to have contaminates in its water source. In this example, the bottle 10 is filled at a location where the placement of the liquid is controlled and the bottle is then shipped to the desolate region of the world for consumption. Once there and ready for use, the nipple can then be attached to the container 10 where the risk of contamination resulting while having an open container is minimized. Furthermore, once used, having the nipple locked, or permanently secured to the container, prohibits the container from being reused, this time possibly with contaminated liquids.

The invention and its advantages will be understood from the forgoing description and it will be apparent that various changes may be made in the form, construction and arrangement of the parts of the invention without departing from the spirit and scope thereof or sacrificing its material advantages, the arrangement hereinbefore described being merely by way of example, and I do not wish to be restricted to the specific form shown or uses mentioned, except as defined in the accompanying claims.

What is claimed is:

1. A system for permanently securing a nipple to a container, the system comprising:
an insertion element as part of a nipple or a container;
a receiving element as part of the nipple or the container that does not include the insertion element; and
a locking element as part of the insertion element and/or the receiving element to prohibit the nipple from being removed from the container.

2. The system according to claim 1, further comprising a piercing device as part of the nipple to open a covering on the container prior to and/or during securing the nipple to the container.

3. The system according to claim 1, wherein the nipple comprises a baby bottle nipple, sipper lid, a lid with a spout, and/or a sports bottle top.

4. The system according to claim 1, wherein the nipple comprises a cover that provides for a control over a flow of liquid from the container through an opening in the nipple.

5. The system according to claim 1, wherein the insertion element and the receiving element comprise threads as part of each element that engage each other.

6. The system according to claim 1, wherein at least one of the insertion element and/or the receiving element comprises a channel and the insertion element and/or the receiving element not comprising the channel comprises an engaging element that can travel within the channel.

7. The system according to claim 1, wherein the locking element comprises a locking ridge and/or a detent.

8. An apparatus for securing a nipple to a sidewall of a container, the apparatus comprising:
a nipple with a connection element;
a lip attachment, connected to a sidewall of the container, to receive a connection element on a nipple; and
a locking element to prohibit the nipple from being removed from the lip attachment.

9. The apparatus according to claim 8, wherein the locking element prohibits the nipple from being removed from the lip attachment once the nipple is secured to the lip attachment.

10. The apparatus according to claim 8, wherein the locking element prohibits the nipple from being removed from the lip attachment while securing the nipple to the lip attachment.

11. The apparatus according to claim 8, wherein the nipple comprises a baby bottle nipple, sipper lid, a lid with a spout, and/or a sports bottle top.

12. The apparatus according to claim 8, wherein the nipple comprises a cover that provides for a control over a flow of liquid from the container through an opening in the nipple.

13. The apparatus according to claim 8, wherein the locking element comprises locking ridge and/or a detent.

14. The apparatus according to claim 8, further comprising a piercing device as part of the nipple to open a covering on the container prior to and/or during securing the nipple to the lip attachment.

15. The apparatus according to claim 8, wherein the connection element of the nipple and the lip attachment each comprise threads that engage each other to secure the nipple to the lip attachment.

16. The apparatus according to claim 1, wherein at least one of the connection element of the nipple and/or the lip attachment comprises a channel and the nipple and/or the lip attachment not comprising the connection element comprises an engaging element that can travel within the channel.
